(19) United States
(12) Patent Application Publication
(10) Pub. No.: US 2012/0156453 A1
(43) Pub. Date: Jun. 21, 2012

(54) CRACK REDUCTION AT METAL/ORGANIC DIELECTRIC INTERFACE

(75) Inventors: Mario GONZALEZ, Pietrebais (BE); François Iker, Mont-Saint-Guibert (BE); Takuo Funaya, Tokyo (JP)

(73) Assignees: NEC Corporation, Tokyo (JP); IMEC, Leuven (BE)

(21) Appl. No.: 13/329,109

(22) Filed: Dec. 16, 2011

Related U.S. Application Data
(63) Continuation of application No. PCT/EP2009/057678, filed on Jun. 19, 2009.

(51) Int. Cl. B32B 7/02; H01R 43/00

(52) U.S. Cl. 428/212; 29/825

(57) ABSTRACT

A method of providing a metal interconnect to second structures embedded in organic dielectric material is disclosed. In one aspect, the method includes obtaining a first structure with second structures, e.g., metal pillars, embedded in organic dielectric material. The method further includes, at least at some locations of the first structure, providing a stiffening layer on top of the organic dielectric material, the stiffening layer having a stiffness higher than the stiffness of the organic dielectric material. The method provides an interconnect structure free from cracks at the interface between the second structures and the organic dielectric material.

### CROSS REFERENCE TO RELATED APPLICATIONS

This application is a continuation of PCT Application No. PCT/EP2009/057678, filed Jun. 19, 2009, which is incorporated by reference hereby in its entirety.

### BACKGROUND OF THE INVENTION

1. Field of the Invention

The disclosed technology relates to the field of semiconductor processing, particularly to a semiconductor device and a semiconductor device fabrication method, and more particularly to crack reduction at interfaces between an embedded structure and an organic dielectric.

2. Description of the Related Technology

For large integration and large density of semiconductor devices, etc. it is advantageous to form multilayer interconnections.

In many applications (e.g., die embedding, integrated passives, etc.) embedded structures such as metal (e.g., copper) pillars, silicon dies or other fully embedded stiff structures are embedded in a polymer (e.g., BCB—benzocyclobutene) which may be functioning as an interlayer insulating layer. The embedded structures, e.g., metal pillars, may be used as interconnects in applications like integrated passives or die embedding (UTCS—ultra-thin chip stacking—like approaches). Typical copper pillars have a circular shape with heights ranging from a few to 20 or even more microns. It appears that when using thick embedded structures (above 15 μm height) very high stresses can be generated at the interface between the embedding polymer and the embedded structure. This leads to reliability issues when undergoing standard reliability test (such as a JEDEC test for example).

Typical cracks 10 appearing at the interface 11 between polymer (e.g., BCB) and metal (e.g., Cu) can be observed in the FIB (focused ion beam) cross-sections as illustrated in FIG. 1. Such cracks 10 appear and grow during thermal cycling. In the picture of FIG. 1, the crack 10 has an extent of around 1 μm. The cracks 10 are always generated at the edges of the top surface of the metal pillars, what is consistent with results from FEM (finite element method) simulations proposed in FIG. 3.

Such cracks 10 are not tolerated in a product fabrication process as they are known to be preferred sites for further crack propagations. The inventors have learnt from thermo-mechanical simulations that a crack 10 is initiated at the edge of the top surface of an embedded structure during thermal cycling.

In US-2007/0194412 it is proposed to use a double layer resin layer, of which a first layer contains a filler so as to make the difference in thermal expansion coefficient between the resin layer and the semiconductor substrate small. This solution, hence, is based on polymer engineering—filling polymers with particles. Completely changing materials this way proves to be difficult in some semiconductor method flows. With composite materials it is not always possible to perform photolithography.

### SUMMARY OF CERTAIN INVENTIVE ASPECTS

Certain inventive aspects provide interfaces between embedded structures and organic material which are crack-free, also during and after thermal cycling of a device comprising such interface.

Certain inventive aspects relate to a method for obtaining such crack-fee interfaces between embedded structures and organic material.

In a first aspect, there is a method for providing a metal interconnect to embedded structures embedded in organic dielectric material such as polymer or silicone. The method may comprise obtaining a first structure with second structures embedded in organic dielectric material, and at least at some locations of the first structure providing a stiffening layer on top of the organic dielectric material, the stiffening layer having a stiffness higher than the stiffness of the organic dielectric material.

In one aspect, providing a stiffening layer on top of the organic dielectric material at least at some locations of the first structure may comprise providing the stiffening layer next to edges, e.g., edges of an exposed top surface, of the second structures such as metal pillars, silicon dies, etc. In one aspect, providing a stiffening layer on top of the organic dielectric material may comprise providing a stiffening layer between the organic dielectric material and a metal interconnect layer connecting to the second structures. Providing a stiffening layer on top of the organic dielectric material may comprise providing a stiffening layer between portions of a metal interconnect layer connecting to the second structures.

In one aspect, providing a stiffening layer may comprise providing a dielectric layer comprising inorganic material. The dielectric layer may consist of inorganic material. Alternatively, the dielectric layer may comprise inorganic material, e.g., inorganic particles in an organic matrix.

In one aspect, the stiffening layer may be a single layer, such as a CVD material e.g., Si3N4 or SiO2 or TaN, a polymer, a metal, a layer of inorganic particles in an organic matrix. The stiffening layer may be a multilayer structure for example composed of a plurality of layers of the above materials. In case of a multilayer structure, at least one of the layers may be an inorganic layer or a layer comprising inorganic material.

In one aspect, providing a stiffening layer may comprise providing a dielectric layer having a coefficient of thermal expansion which is lower than the coefficient of thermal expansion of the organic dielectric material. The coefficient of thermal expansion may be as low as possible. The coefficient of thermal expansion may be of particular importance for example in case the organic embedding material is a polymer for which a high polymer curing temperature is involved.

In case the first structure comprises a substrate having a coefficient of thermal expansion, a method may comprise providing as a stiffening layer a dielectric layer having a coefficient of thermal expansion which is close to the coefficient of thermal expansion of the substrate. In one aspect, the deviation between the coefficients of thermal expansion do not deviate from each other more than about 10%.

In one aspect, providing a stiffening layer may comprise providing a dielectric layer having a Young's modulus which is larger than the Young's modulus of the organic dielectric material. The Young's modulus of the stiffening layer may be as high as possible.

In one aspect, a method may comprise, before applying the stiffening layer, recessing the organic dielectric material so as to expose top edges of the embedded structures. Such exposing of the top edges of the embedded structures may comprise recessing the organic dielectric layer, for example by any of CMP or fly cutting.

In a second aspect, there is a first structure comprising second structures, such as e.g., metal pillars or silicon dies, embedded in an organic dielectric material, a metal interconnect to the second structures, and at least at some locations of the first structure, a stiffening layer on top of the organic dielectric material, the stiffening layer having a stiffness higher than the stiffness of the organic dielectric material.

In a first structure according to one aspect, the stiffening layer may be present next to edges of the second structures. The stiffening layer may be present between the organic dielectric material and the metal interconnect layer connecting to the second structures. The stiffening layer may be present between portions of the metal interconnect layer connecting to the second structures.

In one aspect, the stiffening layer may be a dielectric layer. Such dielectric layer may be used for insulation purposes.

In a first structure according to one aspect, the stiffening layer may comprise an inorganic material. The stiffening layer may be made of a composite material, e.g., inorganic particles in an organic matrix. Alternatively, the stiffening layer may consist of inorganic material.

In one aspect, the stiffening layer may be a single layer, such as made of CVD material e.g., Si3N4 or SiO2 or TaN, a polymer, a metal, a layer of inorganic particles in an organic matrix. In one aspect, the stiffening layer may be a multilayer structure for example composed of a plurality of layers of the above materials. In case of a multilayer structure, at least one of the layers may be an inorganic layer or a layer comprising inorganic material.

The stiffening layer may have a coefficient of thermal expansion which is lower than the coefficient of thermal expansion of the organic dielectric material.

In a first structure according to one aspect, the first structure may comprise a substrate having a coefficient of thermal expansion, and the coefficient of thermal expansion of the stiffening layer may be close to, for example deviating no more than about 10% from the coefficient of thermal expansion of the substrate.

The stiffening layer may have a Young's modulus which is higher than the Young's modulus of the organic dielectric material.

In a first structure according to one aspect, the stiffening layer may have a thickness such that, taking into account the other material properties, it provides the desired stiffness. The stiffening layer may have a thickness between about 2 μm and 10 μm. The thickness may be such that the stiffening layer avoids failures such as cracks or buckling on the stiffening layer during deformation thereof under influence of external forces.

It is an advantage of one aspect that standard materials and standard process steps can be used.

Particular and preferred aspects of the invention are set out in the accompanying independent and dependent claims. Features from the dependent claims may be combined with features of the independent claims and with features of other dependent claims as appropriate and not merely as explicitly set out in the claims.

Certain objects and advantages of certain inventive aspects have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1(a) shows a FIB cross-section illustrating cracks at a BCB—Cu interface after thermal cycling from 125° C. to −55° C. FIG. 1(b) is an enlarged detail of FIG. 1(a).

FIG. 2 illustrates a structure used for FEM simulations, considering a substrate provided with a copper pillar surrounded by polymer.

FIG. 3 shows simulation results of principal stresses at −55° C. in a Cu pillar (17.5 μm diameter) surrounded by BCB.

FIG. 4 shows simulation results of principal stresses at −55° C. in a Cu pillar (17.5 μm diameter) surrounded by silicone.

FIG. 5 shows simulation results illustrating the influence of the Cu pillar diameter on stress generated between the Cu pillar and the surrounding polymer.

FIG. 6 illustrates a structure used for simulation of embedded Cu interconnect in polymer with a “stiffening layer”.

FIG. 7 illustrates a prior art interconnect structure.

FIG. 8 to FIG. 18 illustrate method steps of a first flow according to one embodiment for manufacturing a crack-free interface between embedded structures and surrounding organic dielectric material.

FIG. 19 to FIG. 21 illustrate the last method steps of a second flow according to one embodiment for manufacturing a crack-fee interface between embedded structures and surrounding organic dielectric material.

FIG. 22 illustrates a structure according to one embodiment, where the stiffening layer consists of a multilayer structure.

The drawings are only schematic and are non-limiting. In the drawings, the size of some of the elements may be exaggerated and not drawn on scale for illustrative purposes.

Any reference signs in the claims, referring to the drawings, shall not be construed as limiting the scope of the present invention.

In the different drawings, the same reference signs refer to the same or analogous elements.

### DETAILED DESCRIPTION OF CERTAIN ILLUSTRATIVE EMBODIMENTS

In order to better assess the problem and the solution according to certain embodiments, prior art devices generating cracks have been simulated. Such cracks may not prevent a device from working, but they may propagate until, for example, a top surface of a device, so that humidity can enter the device and deteriorate it. Furthermore, a capacitance reduction might be observed because air or vacuum are present in the cracks. Such capacitance reduction is not controllable at all. Performance of devices with cracks is low. Indirectly, cracks will accelerate other failure modes.

### Simulation Conditions

The simulations are performed on a first structure, taking into account a metal pillar 20, also called second structure, surrounded by an organic dielectric 21, on a substrate 22. FIG. 2 shows the standard first structure used for the simulations. Simulations are thermomechanical simulations starting from the curing temperature of BCB (250° C.) which is the stress free state in the present simulations; the structure is then cooled down to −55° C. (similar to the thermal cycling tests performed on actual samples) after which temperature is ramped up to 125° C. (again to mimic actual thermal cycle conditions).

Table 1 hereinbelow gives the mechanical properties used for the different materials considered in this simulation.

TABLE 1
Mechanical properties of materials considered in simulation

| | Young's | Tensile | CTE | Poisson's |
|---|---|---|---|---|
| Material | modulus (GPa) | strength (MPa) | (10⁻⁶/° C.) | ratio, v |
| Copper | 117 | — | 16.7 | 0.30 |
| BCB | 3 | 80-94 | 50 | 0.30 |
| WL-5150 | 0.150 @ 20° C. | | 236 | 0.45 |
| Silicon | 169 | — | 2.3 | 0.26 |

### Simulation Results

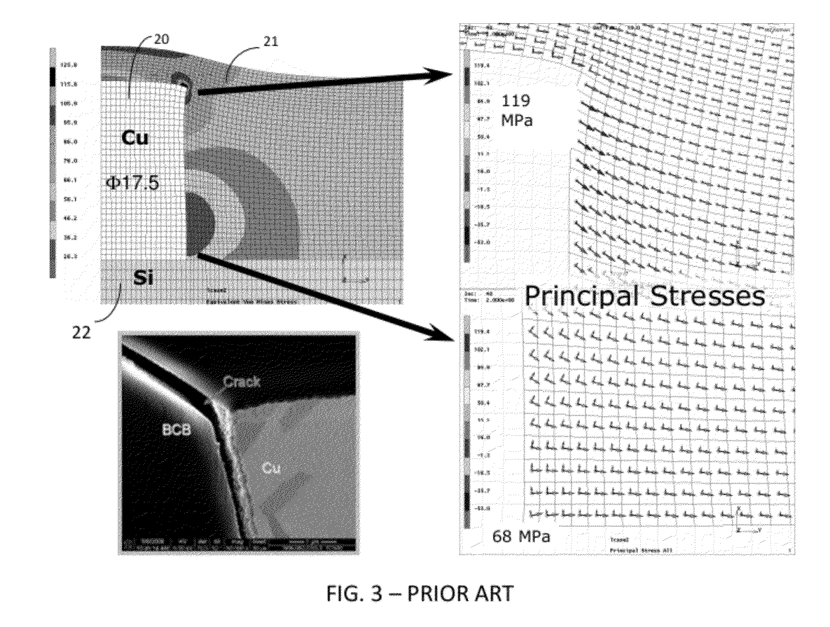

A first simulation considered as the metal pillar 20 a Cu pillar having a 17.5 μm diameter surrounded by BCB as the organic dielectric 21. The substrate 21 was a silicon substrate. The results obtained when simulating a thermal cycle (from 250° C. to −55° C.) showed that high tensile stresses are reached at the BCB-copper interface when going from 250° C. (BCB curing temperature) to −55° C. The principal stresses are shown in FIG. 3.

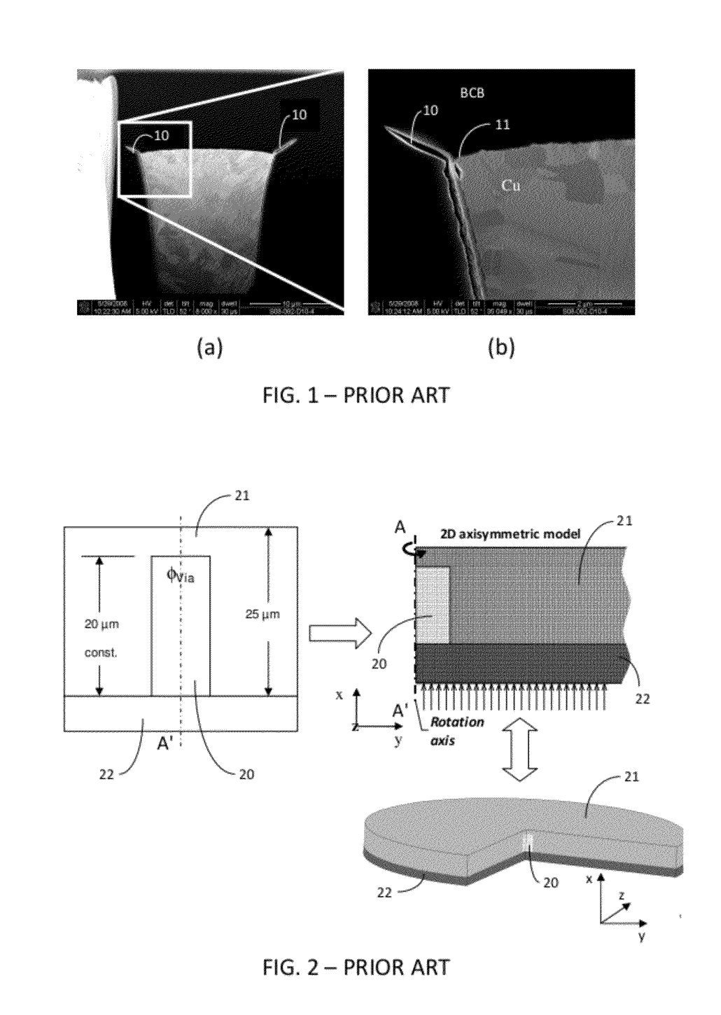

The results obtained with this first simulation do fit with the observation made on actual samples after thermal cycle. A maximum stress can be observed at the edges of the top surface of the Cu pillars 20 where what seems to be the origin of the crack propagation appears in the FIB cross-section illustrated in FIG. 1. A stress of 119 MPa has been computed, where the tensile strength of BCB is between 80 and 90 MPa.

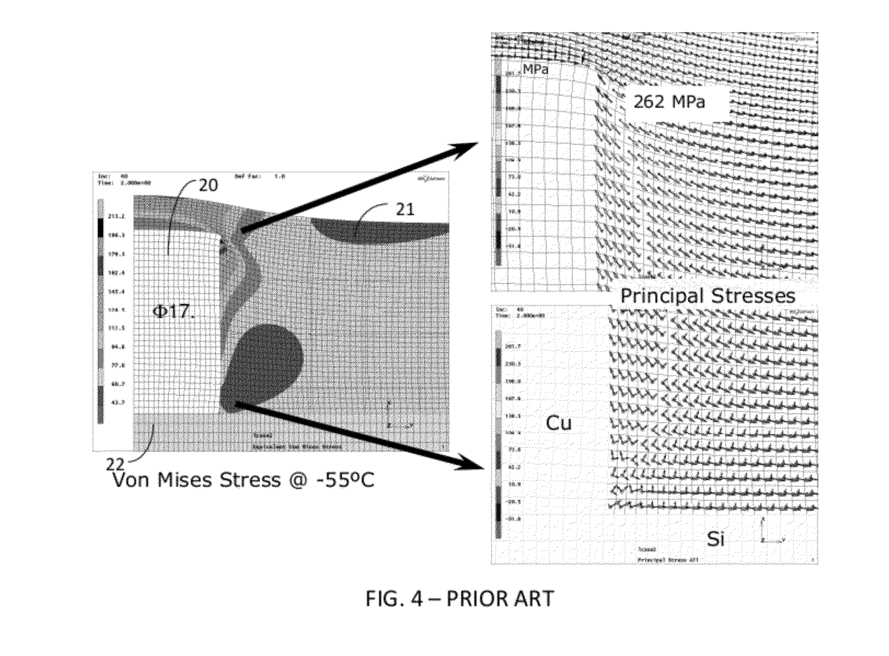

Similar simulations have been performed, replacing the BCB by silicone (e.g., WL-5150) and the same conclusion has been reached: stresses at the edges of the top surface of the Cu pillar 20 are very high leading to fracture of the silicone. Results are illustrated in FIG. 4. A stress of 262 MPa has been computed, which is even higher than the one obtained with BCB. This can be explained by the very large CTE (coefficient of thermal expansion) value of silicone 236×10⁻⁶/° C. versus 50×10⁻⁶/° C. for BCB.

### Impact of Geometry of Embedded Structures, Also Called Second Structures, on Stress

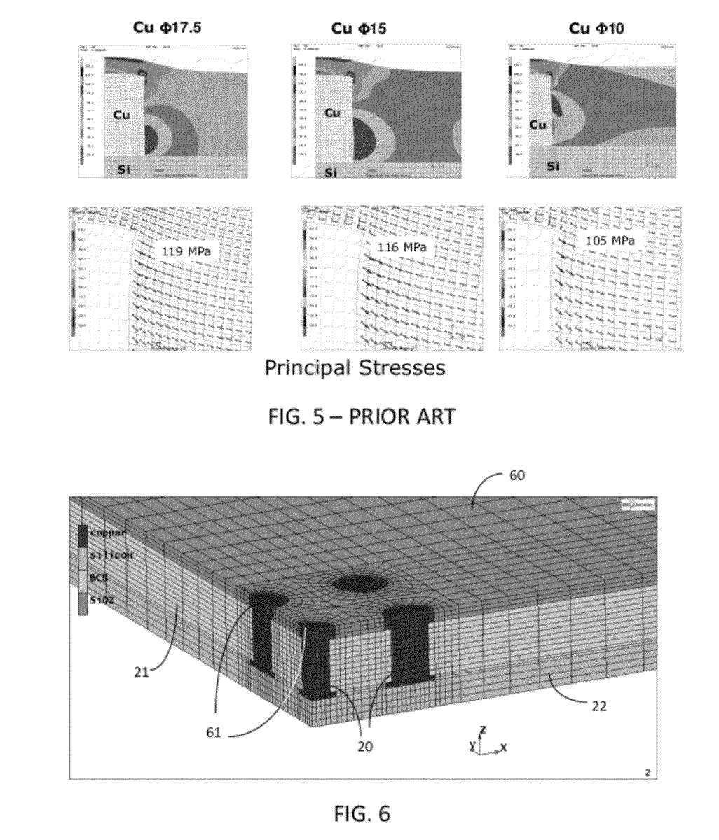

In order to better understand the impact of geometry of the embedded structures e.g., metal pillars 20, on the stress distribution and maximum stress values, similar simulations were performed with different diameters of Cu pillars 20. It appeared that reducing pillar diameter leads to a small reduction of stress but not enough to avoid failure of the organic dielectric, e.g., polymer, at the metal, e.g., Cu, edge in the range of dimensions studied (diameters ranging from 17.5 μm down to 10 μm). Simulations results are illustrated in FIG. 5.

Furthermore it has been found that the effect of cracking was worse for higher embedded structures, e.g., pillars. This has been explained in that stresses grow bigger along the height of the embedded structures, e.g., pillars.

### Solution According To One Embodiment

According to one embodiment, the problem described above is solved by adding a stiffening layer, at least at some locations of the first structure, on top of the organic dielectric material. In one embodiment this may include adding a stiffening layer between the organic dielectric material and a metal interconnect layer, at the level of the top of the interface between the organic dielectric and the embedded structure, also called second structure, underneath a metal interconnect layer connecting to the embedded structure. In another embodiment this may include adding a stiffening layer in between portions of the metal interconnect layer.

The organic dielectric/embedded structure may for example be a BCB—Cu structure; however, the invention is not limited thereto. Other examples include a die embedded in polymer such as silicone, Rohm and Hass (8023-10), etc. . . .

The desired properties of the stiffening layer are:
a coefficient of thermal expansion (CTE) as low as possible, at least lower than the CTE of the organic dielectric, e.g., polymer, used for embedding the metal pillars, and/or
a Young's modulus (E) as high as possible, at least higher than the Young's modulus of the organic dielectric, e.g., polymer, used for embedding the metal pillars. Hence the required stiffness of the stiffening layer depends on the stiffness of the underlying organic dielectric material.

The stiffening layer hence has a stiffness, i.e., a resistance against deformation by an applied force, which depends on the E*CTE value and the geometry of the stiffening layer. The stiffness of the stiffening layer should be larger than the stiffness of the underlying organic dielectric layer.

In one embodiment, the stiffness of the stiffening layer is close to that of the substrate; for example the stiffness of the stiffening layer may deviate less than about 10% from the stiffness of the substrate. It is an advantage of one embodiment that the stiffening layer is stiff with respect to the underlying organic dielectric. It is an advantage of one embodiment that the stiffening layer has a temperature mismatch with respect to the material, e.g., metal, of the embedded structure which is smaller than the temperature mismatch between the organic dielectric and the material, e.g., metal, of the embedded structure.

The stiffening layer may comprise inorganic material. In one embodiment, the stiffening layer may completely consist of inorganic material. In another embodiment, the stiffening layer may be made from composite material, such as organic material comprising inorganic particles. In one embodiment, the stiffening layer may comprise organic materials. The stiffening layer may consist of an organic material. Organic materials are most often softer than inorganic materials. In that case an inorganic stiffening layer is most often preferred, as it is most often more stiff than an organic stiffening layer with same dimensions.

In one embodiment, the stiffening layer may be a single layer. The single layer may be a layer consisting of a single material. In alternative embodiments, the single layer may be a layer of composite material. In another embodiment, the stiffening layer may be a multilayered structure comprising a plurality of suitable layers or materials, for example a combination of polymer layers and/or dielectric CVD layers and/or layers comprising organic material and/or layers comprising inorganic material. In one embodiment, a metal may be applied, optionally “sandwiched” in between dielectric layers.

In case only one material or only one layer is used for the stiffening layer it should be non-conductive or insulating to avoid shorts in the underlying layers/devices. In general, for example in case the stiffening layer comprises a plurality of materials or layers, the stiffening layer should at least have a non-conducting or insulating bottom layer, in contact with the wafer or devices, to avoid shorts in the underlying layers/devices. A conductive top layer or intermediate layer can be used. Furthermore, layers at the bottom or in the stack can be used for specific reasons such as adhesion, stress relieve . . . .

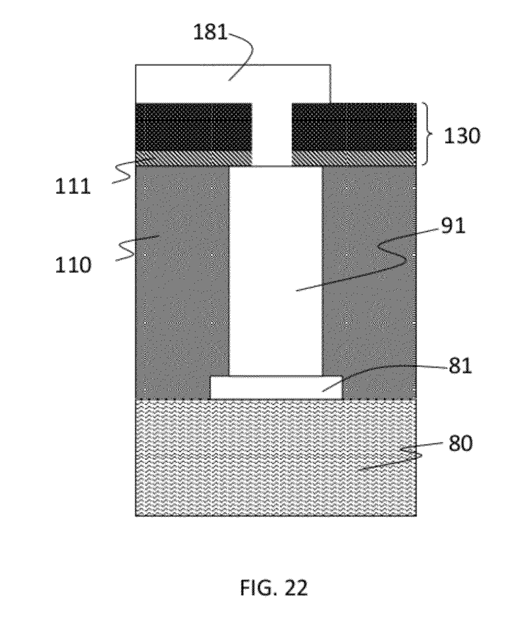

An example of a first structure having a multilayer structure as stiffening layer 130 is illustrated in FIG. 22, which shows a substrate 80, a part of a seed layer 81, a metal pillar 91 embedded in an organic dielectric material 110, a stiffening layer 130 being a multilayer comprising a first insulating layer 111, for example a layer of the same organic dielectric material as the embedding material 110 and a second layer providing the required stiffness characteristics to the stiffening layer 130, and a metal interconnect 181.

The choice for a dielectric for the stiffening layer is application related since electrical functionality of any device built on an interconnect built up on a stiffening layer would be short-circuited if a conductive material (e.g., metal) would be used as the stiffening layer on top of the organic dielectric/metal structure. In case the stiffening layer consists of only one material the material should be non-conductive or insulating to avoid shorts in the underlying layers/devices. In case the stiffening layer comprises different materials, for example a multilayer structure, at least the bottom layer, being in contact with the device wafer, should be non-conducting or insulating to avoid shorts in the underlying layers/devices. A conductive top layer and/or intermediate layers can be used.

If the substrate is Si, examples of materials which could be used as a stiffening layer include, but are not limited thereto, silicon oxide (SiO₂) and silicon nitride (Si₃N₄). Any other suitable material could be used if thick enough layers can be deposited, for example TaO, TaN, diamond, Al₂O₃. The thickness of the stiffening layer depends on the material properties to reach a sufficient stiffness value. In particular embodiments, the thickness of the stiffening layer may be in the range of a few microns, e.g., between about 2 μm and 10 μm, for example 5 μm. The thickness of the stiffening layer has to be high enough to avoid failures, e.g., cracks and/or buckling, of the stiffening layer during the deformation thereof under influence of the internal stresses. The choice of the stiffness of the layer depends on the exact geometry of the locations where the cracks occur. Furthermore the thicker the stiffening layer, the lower the required stiffness of the material that can be used. In case of a thin stiffening layer, a higher stiffness will be used to avoid cracks (when compared to a thicker stiffening layer).

According to one embodiment, a stiff material, i.e., a material having a stiffness higher than the stiffness of the organic dielectric, is applied to locally stiffen the structure at the location where the cracks normally initiate. Applying a stiff material with properties close to the substrate is mechanically equivalent to reduce the pillar height, hence reduce the crack build-up along the vertical direction of the embedded structure.

The choice of the stiffness of the layer depends on the exact geometry of the locations where the cracks occur. Furthermore the thicker the stiffening layer, the lower the stiffness that is needed for the material used. In case of a thin stiffening layer, a higher stiffness is needed to avoid cracks when compared to a thicker stiffening layer.

This means, in accordance with the information obtained from the FEM simulations in FIG. 1, that the stiff material applied according to one embodiment should be in contact with the top edges of the embedded structure, e.g., Cu pillar. To make sure of that, in accordance with one embodiment a recess of the structure comprising the embedded structure and the organic dielectric, e.g., Cu—BCB structure, may be performed in order to create a flat embedded structure/organic dielectric surface, e.g., a flat BCB—Cu surface, on which a stiffening layer can be deposited and patterned according to one embodiment.

Simulations have been performed, mimicking the structures with a stiffening layer as described above to get more information on the efficiency and impact of the use of a “stiffening layer” according to one embodiment. FIG. 6 proposes a sketch of the simulated structures, comprising a substrate 22, e.g., a silicon substrate, embedded structures such as metal pillars 20, e.g., Cu pillars, embedded in an organic dielectric layer 21, e.g., a BCB layer, and with a stiffening layer 60 on top, e.g., a SiO₂ layer or a Si₃N₄ layer. Holes in the stiffening layer 60 above the embedded structures 20 are filled with a second metal 61 for forming a metal interconnect.

From those simulations, it has been found that by adding an about 5 μm thick Si₃N₄ layer 60 on top of a Cu—BCB layer 20, 21 allows decreasing the peak stress value from about 130 MPa (without stiffening layer being present) to 86 MPa (with stiffening layer present according to one embodiment). Using an about 5 μm thick SiO₂ layer 60 led to the same peak stress value (86 MPa). In general the stiffness of a material is related to its thickness and its Young modulus; the CTE gives its deformation for different temperatures. The thicker the stiffening layer the stiffer the layer will be, and thus the better.

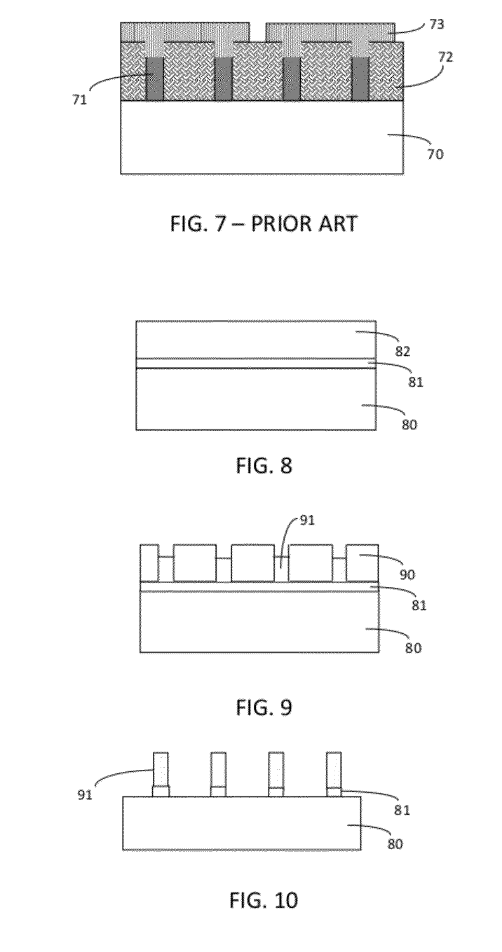

Two different process flows were identified to fabricate such stiffened interconnect structures in accordance with one embodiment. The two approaches are very close to each other and choosing one or the other will depend on the final application of the fabricated device. A prior art structure without stiffening layer can be sketched as in FIG. 7. It illustrates a substrate 70, with embedded structures such as metal 1 pillars 71, e.g., Cu pillars, embedded in a organic dielectric 72, e.g., a polymer such as BCB. The organic dielectric 72 has been opened at the top side to expose the top surface of the metal 1 pillars 71, and a metal 2 interconnect structure 73 has been applied as appropriate to connect to the exposed top surfaces of the metal 1 pillars 72. Such structure presents cracks 10 at the top edges of the embedded structures, e.g., metal 1 pillars 71, as illustrated in FIG. 1.

A first process flow according to one embodiment is illustrated in FIG. 8 to FIG. 18.

The fabrication of an organic dielectric/embedded circuit interface, stiffened with a stiffening layer according to one embodiment is started with the provision of a substrate 80 (FIG. 8). In one embodiment, the term “substrate” may include any underlying material or materials that may be used, or upon which a device may be formed. This substrate 80 may include a semiconductor substrate such as e.g., silicon, a gallium arsenide (GaAs), a gallium arsenide phosphide (GaAsP), an indium phosphide (InP), a germanium (Ge), or a silicon germanium (SiGe) substrate. The substrate 80 may include for example an insulating layer such as a SiO₂ or a Si₃N₄ layer in addition to a semiconductor substrate portion. Thus, the term substrate also includes for example silicon-on-glass or silicon-on sapphire substrates. The term “substrate” is thus used to define generally the elements for layers that underlie a layer or portions of interest, in particular a number of metal pillars 91.

On the substrate 80, the embedded structures, e.g., metal pillars 91, are provided. Metal pillars 91 may typically be fabricated by metal electro plating, e.g., copper electro plating, with a height ranging from about 5 μm to 30 μm. For this, first a seed layer 81 is deposited, for example by sputtering. The seed layer 81 may comprise conductive material; it may for example comprise Ti and Cu in a Ti—Cu or a Ti—Cu—Ti stack, consisting of Ti and Cu layers which are sequentially sputtered over substantially the complete main surface of the substrate 80 one on another.

On top of the seed layer 81, a thick resist layer 82 is applied. The resist layer 82 has a thickness equal to at least the height of the pillars 91 to be formed, hence in the embodiment discussed at least 5 μm. The resist layer 82 may for example be applied on the entire surface of the seed layer 81 by spin coating. The resist layer 82 may be a photoresist, such as Novolac or SU-8.

The photoresist layer 82 may be patterned e.g., by photolithography or photoengraving to form a patterned coating 90 on the seed layer 81 (FIG. 9). By the photolithography or photoengraving step, holes 91 are formed in the resist layer 82 so as to form the patterned coating 90.

An electroplating step is then performed, for example with the seed layer 81 as cathode, and a plating metal anode. This way, the holes in the patterned coating 90 are at least partially filled with metal, so as to form the structures to be embedded, e.g., metal pillars 91. The height of the structures to be embedded, e.g., metal pillars 91, may for example be between 5 μm and 30 μm.

After the electroplating step, the patterned resist 90 is released, for example by a resist strip (FIG. 10). Such resist strip may include a wet stripping step (by means of a solvent) or a dry stripping step (plasma etching).

Once the patterned resist 90 is released, a seed layer etch is performed, consisting in an acid solution based etch of the metal stack used as seed layer 81, so as to remove the parts of the seed layer 81 exposed by removing the patterned resist 90.

After these steps, the structure looks like the one illustrated in FIG. 10.

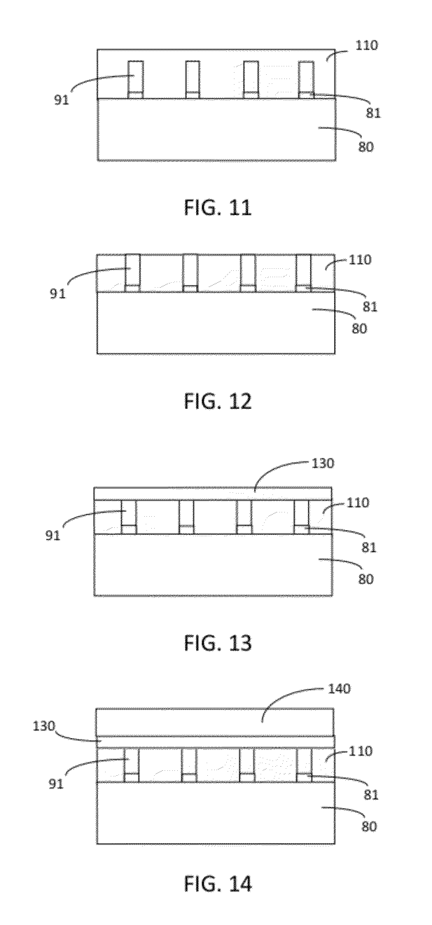

A next step comprises embedding the fabricated structures, e.g., metal pillars 91, in an organic dielectric material 110. The organic dielectric material 110 may be a polymer such as e.g., BCB or silicone. In one embodiment, such organic dielectric material 110 may be applied by spin coating and may require a cure after application. In alternative embodiments, other techniques such as lamination, may be used to apply the organic dielectric material 110. For BCB and silicone, curing temperatures are around 200° C. To cure a polymer in a decent time (˜1 h), typical temperatures are above about 150° C. Using lower temperature is possible but normally requires more time. In preferred embodiments, the organic dielectric material 110 fully covers the structures to be embedded, e.g., metal pillars 91, meaning it has thickness larger than the height of the structures, e.g., pillars 91. After this embedding in the organic dielectric material 110, the structure looks like illustrated in FIG. 11.

After this step, according to one embodiment, the structure is planarized. This requires using a recess technique such as diamond-bit cutting (fly-cutting) or grinding, polishing (CMP). Such techniques allow delivering flat structures and exposing the top edges of the embedded structures, e.g., metal pillars 91 which were identified as the location for the cracks generation. So, recessing of the structure of FIG. 11 down to the embedded structures, e.g., metal pillars 91, is performed. After this recess step, structures can be schematically drawn as in FIG. 12.

At this stage the structures are ready for the deposition of a stiffening layer 130 in accordance with one embodiment, as illustrated in FIG. 13. A stiffening layer 130 is a layer which improves the stiffness of the formed structure. It is a layer with a stiffness higher than the stiffness of the organic dielectric material 110 surrounding the embedded structures, e.g., metal pillars 91. In one embodiment, the stiffening layer 130 may have a Young's modulus which is higher than the Young's modulus of the organic dielectric material 110 surrounding the embedded structures, e.g., metal pillars 91. In one embodiment, the stiffening layer 130 may have a coefficient of thermal expansion which is lower than the coefficient of thermal expansion of the organic dielectric material 110 surrounding the embedded structures, e.g., metal pillars 91. In one embodiment, the coefficient of thermal expansion of the stiffening layer 130 may be close to the coefficient of thermal expansion of the substrate 80, e.g., having a deviation of less than about 10%. The stiffening layer 130 may have any suitable thickness. A thickness of the stiffening layer 130 is suitable if it provides the desired stiffness for the particular material used. In particular the thickness of the stiffening layer 130 is suitable if it avoids failures, e.g., cracks and/or buckling of the stiffening layer 130 during thermal cycling during processing of the device. Suitable thicknesses may for example be between about 2 μm and 10 μm, e.g., 5 μm. The stiffening layer may be applied by any suitable method, for example by CVD (chemical vapour deposition). The stiffening layer 130 may be made from inorganic dielectric material. Some particular types of materials suitable for a stiffening layer 130 are SiO₂ or Si₃N₄.

The stiffening layer 130 then needs a patterning to allow metal interconnections to the underlying embedded structures, e.g., metal pillars 91. Typical patterning techniques require two steps: a resist lithography followed by a material etch which can be based on wet chemical etch or on dry plasma etch.

FIG. 14 illustrates how on top of the stiffening layer 130 a resist layer 140 is applied. The resist layer 140 has a thickness suitable for manufacturing an electrical interconnect structure. The resist layer 140 may for example be applied on the entire surface of the stiffening layer 130 by spin coating. The resist layer 140 may be a photoresist, such as Novolac.

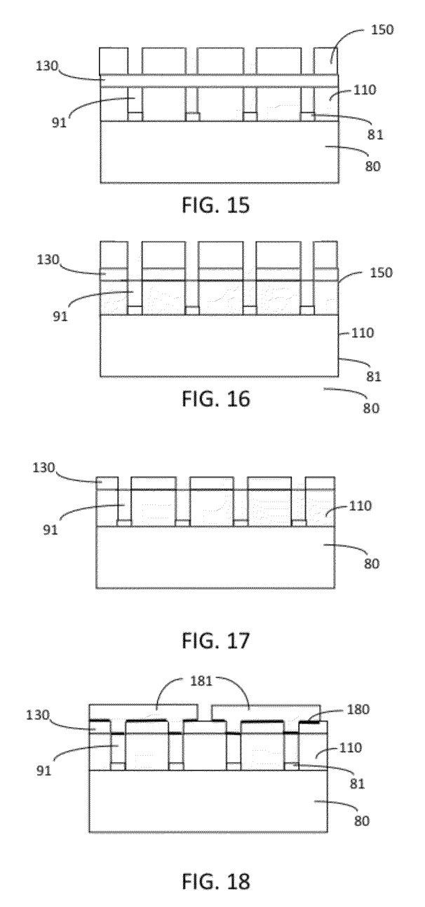

The photoresist layer 140 may be patterned e.g., by photolithography or photoengraving to form a patterned coating 150 on the stiffening layer 130 (FIG. 15). By the photolithography or photoengraving step, holes are formed in the resist layer 140 so as to form the patterned coating 150.

After the resist patterning, a material etch takes place, for removing the exposed parts of the stiffening layer 130. This is illustrated in FIG. 16. Thereafter, the patterned resist layer 150 may be removed, thus resulting in a structure as illustrated in FIG. 17.

It is an advantage of the first flow according to one embodiment that a stiffening layer 130 can be provided for a large area.

To finalize the interconnection structure, a second metal plating is performed. This metal process may include the same steps as described above for the fabrication of the embedded structures, e.g., pillars 91, namely: deposition of a seed layer 180, a lithographic resist process (not illustrated), a metal electroplating for depositing a second metal 181, a resist strip (not illustrated) and an etch of the exposed parts of the seed layer 180. These steps are not illustrated in detail in the drawings. Typical thickness of this electroplated second metal 181 is equal or larger than the thickness of the stiffening layer 130 (a few microns). After this metal process, the structure fabrication is finished and can be schematically drawn as in FIG. 18.

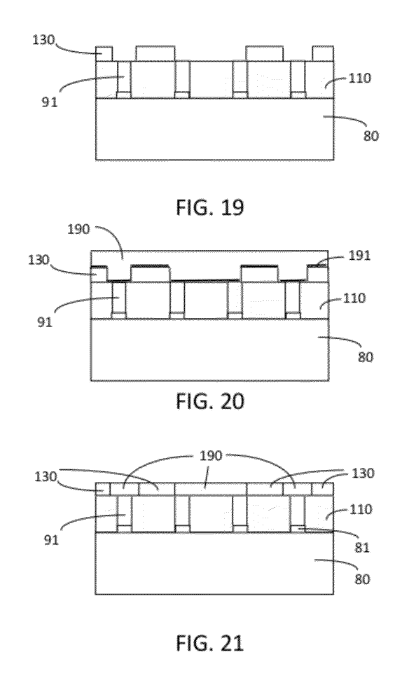

The second process flow according to one embodiment is very similar to the first one until the last metal deposition. Hence steps up to and including steps illustrated in FIG. 17 for the first process flow may also be used in the second process flow. A difference is that the resist patterning as in FIG. 15 and the subsequent removal of stiffening layer material 130 may look slightly different, so that the starting structure for the second process flow may for example look like FIG. 19. For the second process flow, it is proposed to deposit the second metal 190 on the full structure, for example by electroplating. In accordance with this embodiment first a seed layer 191 may be applied, the a metal electroplating process may be performed for depositing a second metal 190 (FIG. 20). Thereafter, according to the second process flow, the second metal layer 190 is recessed, for example by CMP, down to the stiffening layer 130. The seed layer 191 on top of the stiffening layer 130 will be removed by recessing, stopping on the stiffening layer 130. This is much like a damascene process. This allows fabrication of a flat structure which can be preferred in some applications, for example when further stacking of structures is considered. After such a process for the second metal layer 190, the structure looks like schematically illustrated in FIG. 21.

It is an advantage of the second process flow according to one embodiment that a recess technique such as grinding can be used to expose the second metal 190 after deposition and patterning of the stiffening layer 130. Therefore, surface planarity is good.

While the invention has been illustrated and described in detail in the drawings and foregoing description, such illustration and description are to be considered illustrative or exemplary and not restrictive. The foregoing description details certain embodiments of the invention, but is not limited thereto. It will be appreciated that, no matter how detailed the foregoing appears in text, the invention may be practiced in many ways. It should be noted that the use of particular terminology when describing certain features or aspects of the invention should not be taken to imply that the terminology is being re-defined herein to be restricted to include any specific characteristics of the features or aspects of the invention with which that terminology is associated.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

What is claimed is:

1. A method of providing a metal interconnect to second structures embedded in organic dielectric material, the method comprising:
obtaining a first structure with one or more second structures embedded in organic dielectric material; and
providing a stiffening layer on top of the organic dielectric material at least at some locations of the first structure, the stiffening layer having a stiffness higher than the stiffness of the organic dielectric material.

2. The method according to claim 1, wherein providing a stiffening layer on top of the organic dielectric material at least at some locations of the first structure comprises providing the stiffening layer next to edges of the second structures.

3. The method according to claim 1, wherein providing a stiffening layer on top of the organic dielectric material comprises providing a stiffening layer between the organic dielectric material and a metal interconnect layer connecting to the second structures.

4. The method according to claim 1, wherein providing a stiffening layer on top of the organic dielectric material comprises providing a stiffening layer between portions of a metal interconnect layer connecting to the second structures.

5. The method according to claim 1, wherein providing a stiffening layer comprises providing a dielectric layer comprising inorganic material.

6. The method according to claim 1, wherein providing a stiffening layer comprises providing a layer having a coefficient of thermal expansion which is lower than the coefficient of thermal expansion of the organic dielectric material.

7. The method according to claim 1, wherein the first structure comprises a substrate having a coefficient of thermal expansion, wherein providing a stiffening layer comprises providing a layer having a coefficient of thermal expansion which is close to the coefficient of thermal expansion of the substrate.

8. The method according to claim 1, wherein providing a stiffening layer comprises providing a layer having a Young's modulus which is lower than the Young's modulus of the organic dielectric material.

9. The method according to claim 1, further comprising, before applying the stiffening layer, exposing top edges of the second structures.

10. The method according to claim 9, wherein exposing top edges of the second structures comprises recessing the organic dielectric layer by CMP or fly cutting.

11. A first structure comprising:
second structures embedded in an organic dielectric material;
a metal interconnect to the second structures; and
a stiffening layer on top of the organic dielectric material at least at some locations of the first structure, the stiffening layer having a stiffness higher than the stiffness of the organic dielectric material.

12. The first structure according to claim 11, wherein the stiffening layer is present next to edges of the second structures.

13. The first structure according to claim 11, wherein the stiffening layer is present between the organic dielectric material and the metal interconnect layer connecting to the second structures.

14. The first structure according to claim 11, wherein the stiffening layer is present between portions of the metal interconnect layer connecting to the second structures.

15. The first structure according to claim 11, wherein the stiffening layer is a dielectric layer.

16. The first structure according to claim 11, wherein the stiffening layer comprises inorganic material.

17. The first structure according to claim 11, wherein the stiffening layer is a multilayer structure or a layer of composite material.

18. The first structure according to claim 11, wherein the stiffening layer has a coefficient of thermal expansion which is lower than the coefficient of thermal expansion of the organic dielectric material.

19. The first structure according to claim 11, wherein the stiffening layer has a Young's modulus which is higher than the Young's modulus of the organic dielectric material.
